(19) United States
(12) Patent Application Publication
(10) Pub. No.: US 2015/0328562 A1
(43) Pub. Date: Nov. 19, 2015

(54) Method and Structure for Adsorbing Contaminants from Liquid

(71) Applicant: Uproar Labs LLC, Louisville, KY (US)

(72) Inventors: Jeremiah L. Chapman, Louisville, KY (US); Alexander D. Curry, Louisville, KY (US); Alex X. Frommeyer, Louisville, KY (US)

(73) Assignee: Uproar Labs LLC, Louisville, KY (US)

(21) Appl. No.: 14/277,871

(22) Filed: May 15, 2014

(51) Int. Cl. B01D 15/00

(52) U.S. Cl. CPC B01D 15/00; B01D 2215/00

(57) ABSTRACT

Provided are methods and structures for adsorbing contaminants from liquid, and applications thereof. An adsorbing mixture comprised substantially of rice hull ash is added to a liquid with contaminants that is at a preferred temperature for the adsorbing mixture. The adsorbing mixture interacts with the liquid with contaminants for a preferred amount of time and adsorbs the contaminants such that the contaminants are removed from the liquid. The adsorbing mixture is removed from the liquid using a filter that separates the adsorbing mixture from the liquid by way of a preferred pore size that allows the liquid to pass through but not the adsorbing mixture.

### CROSS-REFERENCE TO RELATED APPLICATIONS

None.

### BACKGROUND

The subject embodiments relate to the adsorption of contaminants from liquid, particularly relating to methods of adsorbing free fatty acids and polar compounds from oil. In particular, the embodiments relate to a structure that adsorbs contaminants from liquid without further processing steps.

Cooking oil is used in many applications related to food preparation including the frying of foods, often in a deep fryer. The cooking oil provides a desirable taste, color, and crispness when frying foods at a temperature around 300 to 350 degrees Fahrenheit. Due to this high operating temperature, rapid degradation of the cooking oil occurs at both the oil-air interface and within the oil phase, thus resulting in by-products that directly inhibit the attainment of the desired characteristics of food cooked in the cooking oil. Often, the remedy for this degradation is the disposal and replacement of the cooking oil.

At the oil-air interface, there is a constant introduction of hydrogen, oxygen, and free radicals in the hydrocarbon chains of the oil. As the temperature of the oil increases, the rate of oxidation of the oil also increases, thus creating oxidized fatty acids. The increase of oxidized fatty acids in the oil leads to the oil having undesirable smells and flavor. Therefore, the increase oxidized fatty acids necessitates the replacement of the oil.

Similarly, the process of hydrolysis occurs within cooking oil as food is fried. The oil permeates the surface of the food being fried and displaces water into the surrounding oil phase. Hydrolysis occurs in the oil if the displaced water is not vaporized or removed from the oil. The displaced water and available oxygen react with the hydrocarbon chains comprising the cooking oil to form free fatty acids. The free fatty acids and displaced water result in the cooking oil having a lower smoke point and the formation foam-like, soapy films on the cooking oil. This film acts as a surfactant on the surface of the food placed in the cooking oil, such that more cooking oil is absorbed into the food resulting in greasy, soft food that is undesirable. Accordingly, the rate of hydrolysis increases as the amount of water increases.

Another option exists to prolong the operational life of cooking oil, which is the remediation of the cooking oil by removing contaminants present in the oil. Current methods for removing contaminants from cooking oil include the use of magnesium silicate powder. The process of removing contaminants with magnesium silicate powder requires the cooking oil to be first removed from the vessel used for cooking, often a deep fryer. The cooking oil is then contained in a secondary vessel specifically for the use of filtering the cooking oil. A filter is placed in the secondary vessel prior to pouring the oil in and the magnesium silicate is placed on top of the filter prior to pouring the oil. The oil enters the secondary vessel that is often fitted with a recirculating pump, which recirculates the oil to filter out the contaminants. Upon completion of the filtering, the recirculating pump is used to move the oil back to the vessel used for cooking. The magnesium silicate powder is then removed from the secondary vessel and discarded. The secondary vessel must then be cleaned of remaining sediment and contaminants.

Current methods of remediating cooking oil require the use of a secondary vessel apart from the cooking vessel and the use of hot cooking oil. The current methods of remediating cooking oil are expensive and potentially dangerous to the user. Further, the current methods require a substantial amount of cleanup throughout the process and consume a large amount of materials.

Consequently, food service businesses are in need of a more efficient process for remediating cooking oil. Moreover, food service businesses are in need of a self-contained filtering process that does not require the movement of the oil and a costly secondary vessel. Further still, food service businesses are in need of a low temperature remediation method to provide improved safety and energy efficiency. The complicated and labor-intensive processes of filtering cooking oil have made the process of remediating cooking oil a time-consuming, laborious process that is inefficient. Consequently, a method and structure for remediating cooking oil in a self-contained, low temperature manner is desirable for food service businesses.

### SUMMARY OF EMBODIMENTS

The embodiments described herein meet the objectives stated in the previous section, and provide a method and structure for adsorbing contaminants from a liquid. An adsorbing mixture comprised substantially of rice hull ash is added to a liquid with contaminants that is at a preferred temperature for the adsorbing mixture. The adsorbing mixture interacts with the liquid with contaminants for a preferred amount of time and adsorbs the contaminants such that the contaminants are removed from the liquid. The adsorbing mixture is removed from the liquid using a filter that separates the adsorbing mixture from the liquid by way of a preferred pore size that allows the liquid to pass through but not the adsorbing mixture.

The embodiments further aim to provide a self-contained method of removing contaminants from liquid that does not require the user to pour the adsorbing mixture directly into the liquid with contaminants, often used cooking oil. The self-contained method and structure provides an outer shell made from filter material that encloses the adsorbing mixture. The liquid with contaminants must pass through the outer shell to interact with the adsorbing mixture, thus the adsorbing mixture is not directly added to the liquid. Further, the self-contained method and structure for removing contaminants provides for the removal of all of the adsorbing mixture from the liquid.

A further aim of the embodiments is to provide a method of adsorbing contaminants at lower temperature than is used in current methods. The addition of sodium sulfate to the adsorbing mixture allows for the remediation of cooking oil at a lower temperature. The current method requires the remediation of cooking oil to be performed at a high temperature to vaporize water molecules contaminating the cooking oil. Sodium sulfate acts to adsorb the water molecules at a lower temperature such that the remediation of cooking oil process may be performed at a significantly lower temperature.

The subject embodiments also aim to provide a remediation of cooking oil method that is less labor intensive than the current methods. The subject embodiments allow for the self-contained structure to be placed in the cooking oil without removing the cooking oil from the cooking vessel. Further, the self-contained structure allows for the removal of the adsorbing mixture without the use of secondary screens or filters.

Accordingly several advantages are to provide a method for adsorbing contaminants from a liquid using rice hull ash, to provide a structure for adsorbing contaminants from a liquid using rice hull ash, to provide a self-contained structure for adsorbing contaminants from a liquid using rice hull ash, to provide a method of adsorbing contaminants from cooking oil at low temperatures, and to provide a less labor intensive method of remediating cooking oil. Still further advantages will become apparent from a study of the following descriptions and accompanying drawings.

### BRIEF DESCRIPTION OF THE DRAWINGS

The drawings and embodiments described herein are illustrative of multiple alternative structures, aspects, and features of the embodiments described and claimed herein, and they are not be understood as limiting the scope of the embodiments. It will be further understood that the drawing figures described and provided herein are not to scale, and that the embodiments are not limited to the precise arrangements and instrumentalities shown.

FIG. 1 is a flow chart of the method for adsorbing contaminants from a liquid using rice hull ash, according to multiple embodiments and alternatives.

FIG. 2 is a flow chart of the method for adsorbing contaminants from a liquid using rice hull ash and sodium sulfate, according to multiple embodiments and alternatives.

FIG. 3 is a system diagram of an adsorbing mixture comprised of rice hull ash that is enclosed by a filter material, according to multiple embodiments and alternatives.

FIG. 4 is a perspective view of a structure for adsorbing contaminants from a liquid using rice hull ash, according to multiple embodiments and alternatives.

FIG. 5 is a plan view of a cross-sectioned structure for adsorbing contaminants from a liquid using rice hull ash, according to multiple embodiments and alternatives.

### MULTIPLE EMBODIMENTS AND ALTERNATIVES

According to multiple embodiments and alternatives herein, methods and structures for adsorbing contaminants from liquid and applications thereof shall be discussed in the present section.

A plurality of embodiments comprises methods and structures for adsorbing contaminants from liquid. Methods and structures for adsorbing contaminants from liquid further comprise various structures, methods, and steps.

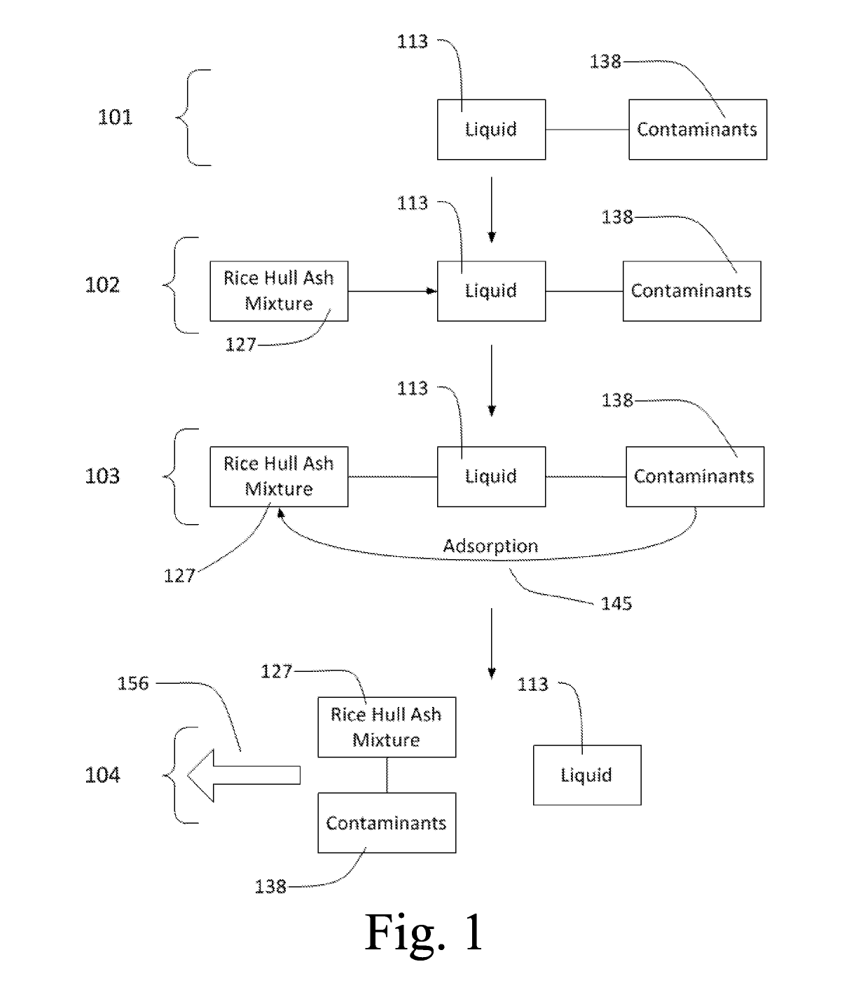

FIG. 1 shows a method of removing contaminants 138 from a liquid 113 by the process of adsorption 145 using an adsorbing mixture 127 that is primarily comprised of rice hull ash. Liquids 113, including, for example, cooking oil, undergo a degradation process 101 during use, especially during deep frying processes, that cause contaminants 138 to form within the oil. For example, contaminants 138 that form in cooking oil may include oxidized fatty acids, free fatty acids, glycerin, polar compounds and combinations thereof. Types of cooking oil include, for example, olive oil, palm oil, soybean oil, canola oil, pumpkin seed oil, safflower oil, peanut oil, grape seed oil, sesame oil, argan oil, rice bran oil, and other vegetable oils, as well as animal-based oils such as butter and lard. Liquids 113 may also include, for example, biodiesel which forms contaminants 138 as byproducts of the trans esterification reaction and include, for example, glycerin and polar compounds. Biodiesel is a vegetable oil and/or animal fat-based diesel fuel comprising long-chain alkyl esters and is typically made by chemically reacting lipids with an alcohol. Accordingly, biodiesel may, for example, be produced from remediated cooking oil such as the liquid 113 illustrated in FIG. 1.

Still referring to FIG. 1, the addition process 102 entails adding a rice hull ash mixture 127, i.e. adsorbing mixture, to the liquid 113 with contaminants 138. Rice hull ash is derived from rice hulls (or rice husks) that are the hard protective coverings of rice grains. Rice hulls undergo combustion producing rice hull ash (also referred to as “RHA”), which is a source of amorphous silica. In some embodiments, the rice hull ash mixture 127 further comprises additional additives including for example hygroscopic materials, silicates, aluminosilicates, chlorides, and combinations thereof. Hygroscopic materials have the ability to attract and hold water molecules (and possible other polar compounds) and may include, for example, sodium sulfate, aluminum potassium sulfate, aluminum sodium sulfate, aluminum sulfate, ferric sulfate, ferrous sulfate, magnesium sulfate, sodium sulfite, sodium thiosulfate, zinc hydrosulfite, zinc sulfate, and combinations thereof.

Again referring to FIG. 1, silicates may be added to the rice hull ash mixture 127 to increase the ability of the rice hull ash mixture 127 to adsorb contaminants 138 from the liquid 113. Silicates may aide in the adsorption of oxidized fatty acids, free fatty acids, polar compounds, and combinations thereof. Silicates to be added to the rice hull ash mixture 127 may include, for example, aluminum calcium silicate, calcium silicate, diatomaceous earth, magnesium silicate, silica aerogel, silicon dioxides, sodium silicate, talc, tricalcium silicate, and combinations thereof. Further, aluminosilicates may be added to the rice hull ash mixture 127 enhance the adsorption capabilities via the synthesis of very high capacity zeolites and microporous structures. Aluminosilicates to be added to the rice hull ash mixture 127 may include, for example, sodium aluminosilicate, sodium calcium aluminosilicate, and combinations thereof. Further still, chlorides may be added to the rice hull ash mixture 127 to aide in neutralizing the acidity of the oil in a cost efficient manner. For example, calcium chloride may be added to the rice hull ash mixture 127.

FIG. 1 further illustrates the adsorption step 103, wherein the rice hull ash mixture 127 removes contaminants 138 from the liquid 113 via adsorption 145. Adsorption 145 is the process of adhesion by which atoms, ions, and molecules in all states of matter adhere to a surface. The adsorption step 103 results in a film of the adsorbate, contaminants 138, on the surface of the adsorbent, rice hull ash mixture 127. The rice hull ash mixture 127 is porous providing voids and abundant surface area for the contaminants 138 to adhere to the surface of the rice hull ash mixture 127. The effectiveness of adsorption 145 in the adsorption step 103 is dependent on a plurality of factors, which may include, for example, liquid 113 temperature, interaction time for adsorption 145, particle size of the rice hull ash mixture 127, volume of rice hull ash mixture 127, volume of liquid 113, and others.

Again referring to the adsorption step 103 of FIG. 1, the liquid 113 is heated to a desired temperature range, which may include, for example, 300 to 400 degrees Fahrenheit, often preferably between 325 and 375 degrees Fahrenheit. This temperature range corresponds to a required interaction time between the liquid 113 and the rice hull ash mixture 127 to remove as many contaminants 138 as possible, which may be between, for example, 10 and 30 minutes. For example, the particle size of the rice hull ash mixture 127 varies between about 0.05 and 1.75 millimeters with an average particle size of about 0.5 millimeters. Further, the volume of rice hull ash mixture 127 corresponds to volume of liquid 113 such that, for example, about 8.5 ounces of rice hull ash mixture 127 is suitable for adsorbing 145 contaminants 138 from about 60 pounds of liquid.

Still referring to FIG. 1, the filtering step 104 requires the removal of the rice hull ash mixture 127 with the adsorbed contaminants 138 from the decontaminated liquid 113 such that the liquid 113 contains substantially less contaminants than prior to the addition step 102 and the adsorption step 103. The removal of the rice hull ash mixture 127 with adsorbed contaminants 138 from the liquid 113 is completed with the use of a filter 156 having a preferred pore size that allows the liquid 113 to pass through and remain in the vessel but does not allow the rice hull ash mixture 127 with adsorbed contaminants 138 to pass through such that the rice hull ash mixture 127 and contaminants 138 are removed from the liquid 113. The filter 156 has an associated material and pore size. The material of the filter 156 may be, for example, filter paper, metal or plastic mesh, flashspun high-density polyethylene fibers (commonly known by the trade name Tyvek®), woven fibers, and others. Further, the filter 156 has a desired pore size that may be, for example, about 50 microns or less. Further still, it is preferred that the filter 156 be made of a material that is both resistant to high temperatures and acidity, such that the filter 156 does not degrade or dissolve when placed in the liquid 113.

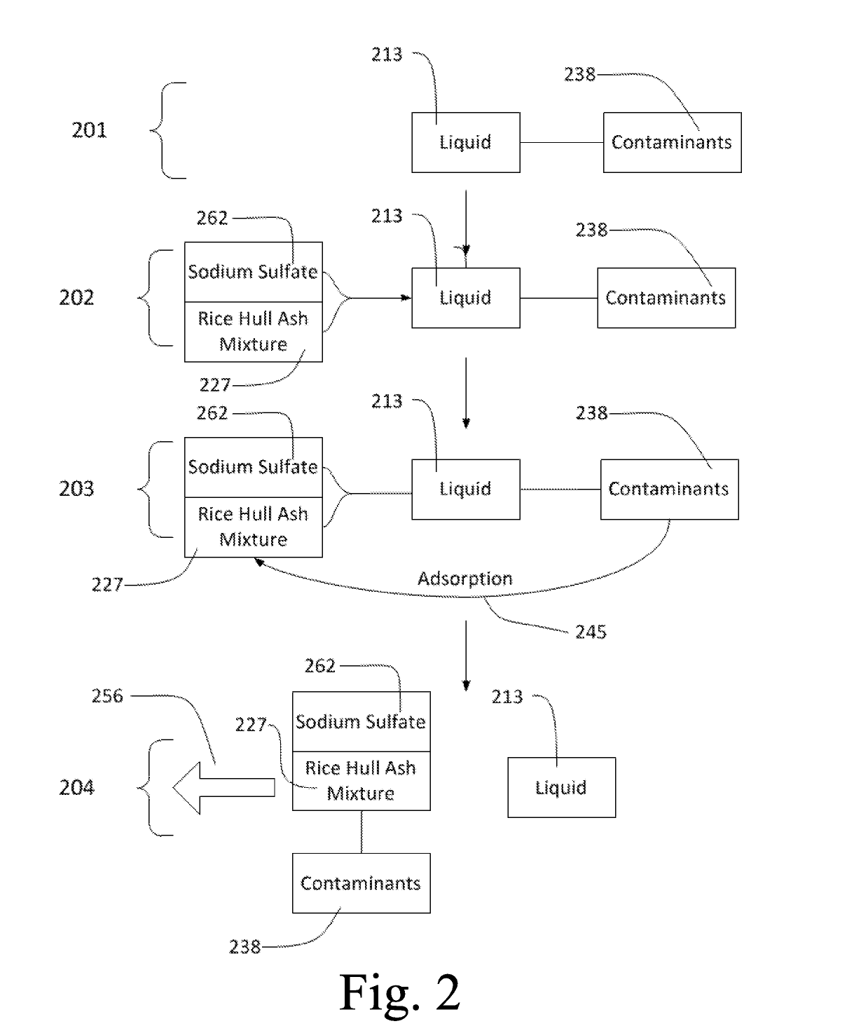

Referring now to FIG. 2, the degradation step 201, wherein contaminants 238 form in liquid 213, occurs in the same manner as in degradation step 101 described above, wherein contaminants 138 form in liquid 113. Accordingly, the addition step 202 is similar to addition step 102 shown in FIG. 1 with the exception that sodium sulfate 262 is added to the rice hull ash mixture 227. The combination of sodium sulfate 262 and rice hull ash mixture 227 is added to liquid 213 with contaminants 238. Sodium sulfate 262 is a hygroscopic material additive that acts to remove polar compounds, such as water, from the liquid 213. Sodium sulfate 262 is the sodium salt of sulfuric acid and exists in the adsorbing mixture in a number states including, for example, anhydrous and various levels of saturation up to hydration due to its high propensity to adsorb water and the large amounts of water vapor present in the environment. Accordingly, the saturation level of the sodium sulfate 262 when it enters the liquid 213 with contaminants 238 may vary based on the amount of moisture in the environment surrounding the liquid 213. Distribution and storage conditions of the sodium sulfate 262 may also vary the saturation level.

Again referring to FIG. 2, the adsorption step 203 varies greatly from the adsorption step 103 shown in FIG. 1 in both the desired temperature range and interaction time. The process of adsorption 245 acts in the same manner as adsorption 145 present in adsorption step 103. The rice hull ash mixture 227 and sodium sulfate 262 operate via adsorption 245 to adsorb the contaminants 238 from the liquid 213. The sodium sulfate 262 is often biased to the adsorption 245 of polar compounds, such as water, in adsorption step 203. As in adsorption step 103, the liquid 213 with contaminants 238 is heated to a desired temperature in adsorption step 203. For example, the liquid 213 with contaminants 238 is heated to a desired temperature range between about 60 and 120 degrees Fahrenheit, often preferably between 80 and 100 degrees Fahrenheit. Consequently, the desired temperature range of adsorption step 203 provides for the elimination of further degradation of the liquid 213 due to high temperature oxidation, resulting in the formation of more contaminants 238, as is present in degradation step 201. This desired temperature range helps to further reduce contaminants 238 in liquid 213 by not creating further degradation in adsorption step 203. This temperature range of adsorption step 203 corresponds to a required interaction time between the liquid 213 and the rice hull ash mixture 227 and sodium sulfate 262 to remove as many contaminants 238 as possible, which may be between, for example, 20 and 60 minutes.

FIG. 2 further illustrates filtering step 204 that occurs in the same manner as filter step 104 shown in FIG. 1. In filtering step 204, rice hull ash mixture 227 and sodium sulfate 262 with adsorbed contaminants 238 is removed from liquid 213 with use of filter 256. Filter 256 is the same as filter 156 shown and described in FIG. 1 above.

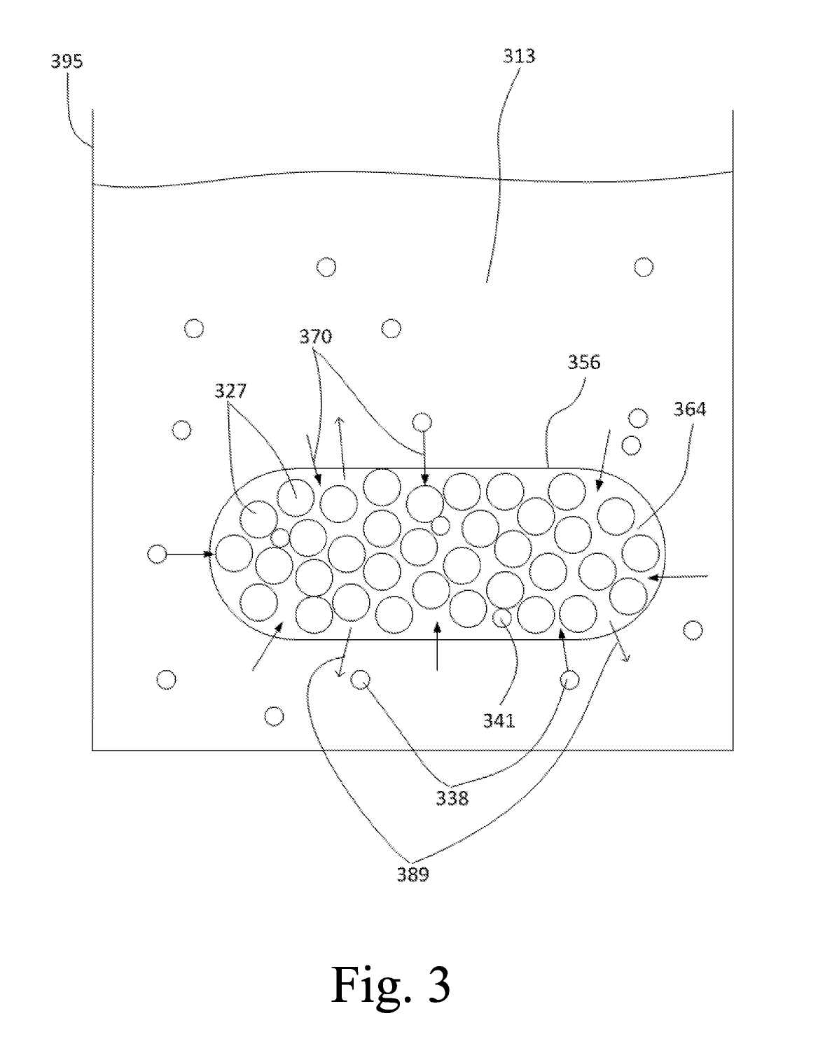

FIG. 3 illustrates the interaction of rice hull ash mixture 327 fully enclosed by filter 356 when placed in liquid 313 with contaminants 338 retained in vessel 395. Rice hull ash mixture 327 is consistent with rice hull ash mixture 127 illustrated and described in FIG. 1 above. Similarly, liquids 313,364 are consistent with liquid 113 described in FIG. 1 above with the exception of liquid 364 being presently contained within the filter 356 and liquid 313 being presently contained within the vessel 395. Further, contaminants 338, which are contained in liquid 313, and contaminants 341, which are contained within filter 356 and adhered to the surface of the rice hull ash mixture 327, are consistent with contaminants 138 described in FIG. 1 above. Furthermore, filter 356 is consistent with filter 156 described in FIG. 1 above.

Still referring to FIG. 3, liquid 313 with contaminants 338 is retained in vessel 395, wherein the contaminants 338 are formed in the liquid 313 in a process similar to the degradation step 101 described in FIG. 1. The rice hull ash mixture 327 is fully enclosed by the filter 356 such that rice hull ash mixture 327 does not leave the filter 356 in any substantial amount during the adsorption step. Accordingly, the filter 356 has a pore size that is smaller than the majority of particles that make up the rice hull ash mixture 327. In some embodiments, the rice hull ash mixture 327 further comprises additives including, for example, hygroscopic materials, silicates, aluminosilicates, chlorides, and still others. One common example of an additive is sodium sulfate, such as, for example, sodium sulfate 262 described in FIG. 2 above.

Again referring to FIG. 3, the rice hull ash mixture 327 fully enclosed by filter 356 is added to the liquid 313 with contaminants 338 retained in vessel 395. The liquid 313 with contaminants 338 passes through the filter 356, as indicated by lines 370, and, subsequently, becomes liquid 364 that is within the filter 356 and contaminants 341 within the filter 356. The contaminants 341 are adsorbed by the rice hull ash mixture 327 and adhere to the surface of the particles that make up the rice hull ash mixture 327, as illustrated in FIG. 3. As the contaminants 341 are adsorbed by the rice hull ash mixture 327, the amount of contaminants 341 suspended within the liquid 364 decreases. The liquid 364 then passes back through the filter 356, as indicated by lines 389, and again becomes liquid 313 retained in vessel 395. As the interaction time elapses, the amount of contaminants 341 adsorbed by the rice hull ash mixture 327 increases, and, consequently, the amount of contaminants 338 suspended in liquid 313 decreases such that liquid 313 has less contaminants 338. As liquid 364 pass back out of the filter 356, shown by lines 389, the contaminants 341 are retained within the filter 356 as the contaminants 341 are adhered to the surface of the particles that make up the rice hull ash mixture 327, which has an average particle size larger than the pore size of the filter 356. After the desired interaction time has elapsed, the rice hull ash mixture 327 enclosed by the filter 356 with the adsorbed contaminants 341 is removed from liquid 313 and vessel 395 such that the contaminants 341 are substantially retained in the filter 356.

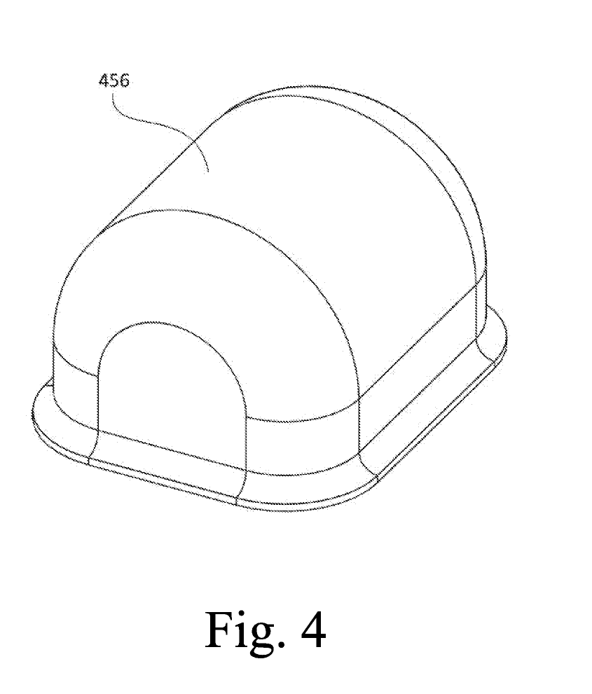

FIG. 4 shows a structure for adsorbing contaminants from a liquid. The structure is comprised of an outer shell 456 that is made up of a filter material, which is consistent with the filter 156 described by FIG. 1 above. The structure further comprises an adsorbing mixture that is consistent with the rice hull ash mixture 127 described by FIG. 1 above. The adsorbing mixture is fully enclosed by the outer shell 456 such that liquid with contaminants must first pass through the outer shell 456 before interacting with the adsorbing mixture. Often, for example, the liquid is consistent with liquid 113, and the contaminants are consistent with contaminants 138, both illustrated by FIG. 1 above.

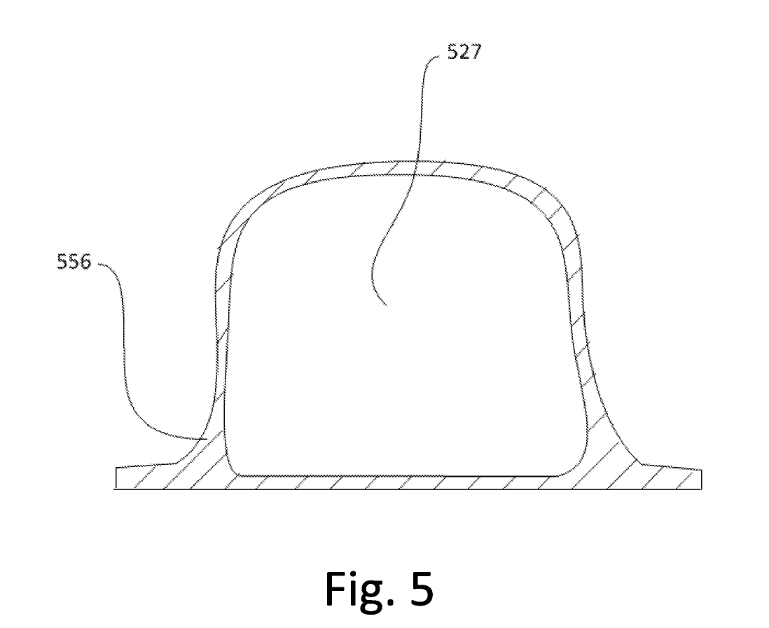

FIG. 5 illustrates a cross-section of the structure shown in FIG. 4. The outer shell 556 fully encloses the adsorbing mixture 527, wherein the outer shell 556 is comprised of a filter that is consistent with filter 156 illustrated by FIG. 1. In some embodiments, for example, the adsorbing mixture 527 is consistent with the rice hull ash mixture 127 described by FIG. 1 above. Accordingly, the outer shell 556 may be formed around the adsorbing mixture 527 such that the outer shell 556 begins as an open shell and the adsorbing mixture 527 is placed within the outer shell 556. The outer shell 556 is then closed around the adsorbing mixture 527 such that the adsorbing mixture 527 is fully enclosed by the outer shell 556. The outer shell 556 is then sealed to substantially retain the adsorbing mixture 527 within the outer shell 556.

It will be understood that the embodiments described herein are not limited in their application to the details of the teachings and descriptions set forth, or as illustrated in the accompanying figures. Rather, it will be understood that method and structure of adsorbing contaminants from liquid, as taught and described according to multiple embodiments disclosed herein, is capable of other embodiments and of being practiced or carried out in various ways.

Also, it is to be understood that the phraseology and terminology used herein is for the purpose of description and should not be regarded as limiting. The use herein of “including,” “comprising,” “i.e.,” “containing,” or “having,” and variations of those words is meant to encompass the items listed thereafter, and equivalents of those, as well as additional items. Unless the meaning is clearly to the contrary, all ranges set forth herein are deemed to be inclusive of the endpoints.

Accordingly, the descriptions herein are not intended to be exhaustive, nor are they meant to limit the understanding of the embodiments to the precise forms disclosed. It will be understood by those having ordinary skill in the art that modifications and variations of these embodiments are reasonably possible in light of the above teachings and descriptions.

What is claimed is:

1. A method for adsorbing contaminants suspended in a liquid, comprising:
introducing an adsorbing mixture substantially comprised of rice hull ash, to a liquid having a preferred temperature comprising contaminants that is retained in at least one vessel;
allowing said adsorbing mixture to interact with said liquid for a preferred amount of time; and
removing said adsorbing mixture from said liquid using a filter having a preferred pore size,
wherein said adsorbing mixture adsorbs the contaminants suspended in said liquid such that said liquid comprises substantially less contaminants after interacting with said adsorbing mixture.

2. The method of claim 1, wherein said contaminants are chosen from the group consisting of free fatty acids, oxidized fatty acids, polar molecules, color bodies, glycerin, and combinations thereof.

3. The method of claim 1, wherein said liquid has a temperature from about 300 to about 400 degrees Fahrenheit.

4. The method of claim 1, wherein said adsorbing mixture further comprises sodium sulfate.

5. The method of claim 4, wherein said liquid has a temperature from about 60 to about 120 degrees Fahrenheit.

6. The method of claim 1, wherein said filter encloses said adsorbing mixture, such that said adsorbing mixture contacts said liquid after said liquid passes through said filter.

7. The method of claim 1, wherein said filter is manufactured from the material chosen from the group consisting of flashspun high-density polyethylene fibers, filter paper, metal mesh, plastic mesh, woven fibers, and combinations thereof.

8. The method of claim 1, wherein said filter has a pore size of about no more than 50 microns.

9. The method of claim 1, wherein said interaction time is from about 10 to about 60 minutes.

10. The method of claim 1, wherein said adsorbing mixture further comprises an additional substance chosen from the group consisting of hygroscopic materials, silicates, aluminosilicates, chlorides, and combinations thereof.

11. The method of claim 1, wherein said liquid is chosen from the group consisting of frying oil, biodiesel, and combinations thereof.

12. A structure for adsorbing contaminants suspended in liquid, comprising:
an outer shell comprised of filter material having at least one pore size; and
an adsorbing mixture substantially comprised of rice hull ash,
wherein said adsorbing mixture is arranged to be enclosed by said outer shell, such that liquid with contaminants passes through said outer shell, contacts said adsorbing mixture within the boundaries of said outer shell, and then again passes through said outer shell with substantially less contaminants.

13. The structure of claim 12, wherein said adsorbing mixture is inhibited from passing through said outer shell, such that said filter material has a pore size that allows liquid to pass through said outer shell and does not allow said adsorbing mixture to pass through said outer shell.

14. The structure of claim 12, wherein said filter material is chosen from the group consisting of flashspun high-density polyethylene fibers, filter paper, metal mesh, plastic mesh, woven fibers, and combinations thereof.

15. The structure of claim 12, wherein said pore size is about no more than 50 microns.

16. The structure of claim 12, wherein said contaminants are chosen from the group consisting of free fatty acids, oxidized fatty acids, polar molecules, color bodies, glycerol, and combinations thereof.

17. The structure of claim 12, wherein said adsorbing mixture further comprises sodium sulfate.

18. The structure of claim 12, wherein said adsorbing mixture further comprises an additional substance chosen from the group consisting of hygroscopic materials, silicates, aluminosilicates, chlorides, and combinations thereof.

19. The structure of claim 12, wherein said structure is configured to be placed in said liquid for a time from about 10 to about 60 minutes.

20. The structure of claim 12, wherein said structure is configured to be placed in a liquid chosen from the group consisting of cooking oil, biodiesel, and combinations thereof.

21. A structure for adsorbing contaminants from cooking oil, comprising:
an outer shell comprised of filter material having a pore size of about no more than 50 microns; and
an adsorbing mixture substantially comprised of rice hull ash and sodium sulfate,
wherein said adsorbing mixture is arranged to be enclosed by said outer shell, such that cooking oil with contaminants passes through said outer shell, contacts said adsorbing mixture within the boundaries of said outer shell, and then again passes through said outer shell with substantially less contaminants.
